(19) United States
(12) Patent Application Publication
(10) Pub. No.: US 2018/0341934 A1
(43) Pub. Date: Nov. 29, 2018

(54) ATM WITHDRAWAL QUERY METHOD AND APPARATUS

(71) Applicant: Mastercard International Incorporated, Purchase, NY (US)

(72) Inventors: Elson Rodrigues, Mumbai (IN); Piyush Sharma, Pune (IN)

(73) Assignee: Mastercard International Incorporated, Purchase, NY (US)

(21) Appl. No.: 15/967,230

(22) Filed: Apr. 30, 2018

(30) Foreign Application Priority Data
May 26, 2017 (SG) 10201704310S

(51) Int. Cl. G06Q 20/10

(52) U.S. Cl. CPC G06Q 20/1085

(57) ABSTRACT

There is provided, for a customer, a convenient way of remotely determining whether an ATM is available for a desired withdrawal before physically travelling to the location of the ATM. This convenience is enabled by a polling mechanism to determine parameters of various ATMs. This capability can therefore avoid the potential inconvenience of a customer wasting time and effort going to an ATM only to discover that the ATM is inoperative or is not loaded with sufficient cash or not having desired denominations of currency.

### CROSS-REFERENCE TO RELATED APPLICATIONS

This application claims priority to Singapore Application Serial No. 102017043105, filed May 26, 2017, which is incorporated herein by reference in its entirety.

### BACKGROUND OF THE INVENTION

This invention relates to a method and apparatus for allowing a customer to perform a withdrawal query to determine whether a desired withdrawal amount can be withdrawn from an automated teller machine (ATM).

### DESCRIPTION OF THE PRIOR ART

Automated teller machines (ATMs), also known as cash machines, have been adopted throughout the world as a convenient way of allowing customers of financial institutions to perform financial transactions, especially withdrawing cash. ATMs remove the need for a human bank teller and avoid time based restrictions on financial transactions due to bank opening hours or the like.

A customer seeking to use an ATM may still encounter problems if the ATM runs out of a particular denomination of cash or the ATM is out of order, making financial transactions using that ATM undesirable, as being able to withdraw cash still can lead to issues like a recipient not having sufficient change for the cash obtained from the ATM. However, the customer will only become aware of these problems once the customer has physically arrived at the ATM location and has attempted to make a transaction. This can present a significant inconvenience to the customer, especially if ATMs operated by the customer's financial institution or accepting transactions on behalf of the customer's financial institution are sparsely distributed around the customer.

Accordingly, it would be desirable to provide customers with an ability to avoid such an inconvenience, if possible.

The reference in this specification to any prior publication (or information derived from it), or to any matter which is known, is not, and should not be taken as an acknowledgment or admission or any form of suggestion that the prior publication (or information derived from it) or known matter forms part of the common general knowledge in the field of endeavour to which this specification relates.

### SUMMARY OF THE PRESENT INVENTION

In a first aspect, there is provided a method for allowing a customer to perform a withdrawal query to determine whether a desired withdrawal amount and desired currency denominations can be withdrawn using an automated teller machine (ATM), the method being performed using one or more electronic processing devices. The method includes: receiving, from a client device of the customer, a withdrawal query request including the desired withdrawal amount and desired currency denominations; performing one or more security checks based at least in part on the withdrawal query message; in the event that the one or more security checks are passed, providing a status query message to an acquiring switch associated with a plurality of ATMs; receiving, from the acquiring switch, a status query response indicative of a current status of one or more ATMs; determining, by a polling process, at the acquiring switch, whether the desired withdrawal amount and desired currency denominations can be withdrawn from the one or more ATMs based on the status query response; and providing, to the client device, an indication of whether the desired withdrawal amount and desired currency denominations can be withdrawn using at least one of the one or more ATMs.

In a second aspect, there is provided an apparatus for allowing a customer to perform a withdrawal query to determine whether a desired withdrawal amount in desired currency denominations can be withdrawn using an automated teller machine (ATM). The apparatus includes one or more electronic processing devices configured to: receive, from a client device of the customer, a withdrawal query request including a desired withdrawal amount and desired currency denominations; perform one or more security checks based at least in part on the withdrawal query request; in the event that the one or more security checks are passed, provide a status query message to an acquiring switch associated with a plurality of ATMs; receive, from the acquiring switch, a status query response indicative of a current status of one or more ATMs; determine, by a polling process, at the acquiring switch, whether the desired withdrawal amount and desired currency denominations can be withdrawn from the one or more ATMs based on the status query response; and provide, to the client device, an indication of whether the desired withdrawal amount and desired currency denominations can be withdrawn using at least one of the one or more ATMs.

There is also provided a method for allowing a customer to perform a withdrawal query to determine whether a desired withdrawal amount in desired currency denominations can be withdrawn using an automated teller machine (ATM), the method being performed using a client device. The method includes: obtaining, from the customer, a request to perform a withdrawal query; obtaining, from the customer, an indication of the desired withdrawal amount and desired currency denominations; generating a withdrawal query request including the desired withdrawal amount and desired currency denominations; providing the withdrawal query request to an application server, to thereby cause the application server to determine whether the desired withdrawal amount and desired currency denominations can be withdrawn from one or more ATMs; receiving, from the application server, an indication of whether the desired withdrawal amount and desired currency denominations can be withdrawn using at least one of the one or more ATMs; and presenting the indication to the customer using a display of the client device.

In a final aspect, there is provided a client device for allowing a customer to perform a withdrawal query to determine whether a desired withdrawal amount and desired currency denominations can be withdrawn using an automated teller machine (ATM). The client device is configured to: obtain, from the customer, a request to perform a withdrawal query; obtain, from the customer, an indication of the desired withdrawal amount and desired currency denomination; generate a withdrawal query request including the desired withdrawal amount and desired currency denominations; provide the withdrawal query request to an application server, to thereby cause the application server to determine whether the desired withdrawal amount and desired currency denominations can be withdrawn from one or more ATMs; receive, from the application server, an indication of whether the desired withdrawal amount and desired currency denominations can be withdrawn using at least one of the one or more ATMs; and present the indication to the customer using a display of the client device.

It will be appreciated that the broad forms of the invention and their respective features can be used in conjunction, interchangeably and/or independently, and reference to separate broad forms is not intended to be limiting.

### BRIEF DESCRIPTION OF THE DRAWINGS

An example of the present invention will now be described with reference to the accompanying drawings, in which:—

FIG. 1 is a flow chart of an example of a method for allowing a customer to perform a withdrawal query to determine whether a desired withdrawal amount can be withdrawn using an automated teller machine (ATM);

FIG. 2 is a schematic diagram of an example of a distributed computer architecture;

FIG. 3 is a schematic diagram of an example of a server processing system;

FIG. 4 is a schematic diagram of an example of a client processing system;

FIG. 5 is a schematic diagram of an example of a system configuration for allowing a customer to perform a withdrawal query;

FIGS. 6A to 6D are a flow chart of an example of a method of a customer performing a withdrawal query; and

FIG. 7 is a flow chart of an example of a method of a customer performing a withdrawal query using a map interface.

### DETAILED DESCRIPTION OF THE PREFERRED EMBODIMENTS

There is provided, for a customer, a convenient way of remotely determining whether an ATM is available for a desired withdrawal before physically travelling to the location of the ATM. This convenience is enabled by a polling mechanism to determine parameters of various ATMs. This capability can therefore avoid the potential inconvenience of a customer wasting time and effort going to an ATM only to discover that the ATM is inoperative or is not loaded with sufficient cash or not having desired denominations of currency.

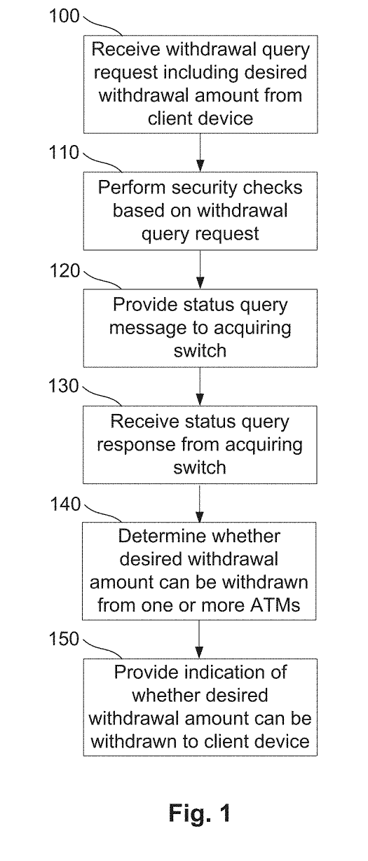

An example of a method for allowing a customer to perform a withdrawal query to determine whether a desired withdrawal amount in desired currency denominations can be withdrawn using an automated teller machine (ATM) will now be described with reference to FIG. 1.

The method as exemplified in FIG. 1 is performed using one or more electronic processing devices, which will be referred to as an application server for the purpose of this example. The application server will be configured to communicate with a client device of the customer and an acquiring switch associated with a plurality of ATMs. Each of the client device and the acquiring switch will be in the form of additional electronic processing devices. Suitable examples of electronic processing devices for providing the application server, the client device and the acquiring switch will be described in more detail below. The application server may communicate with each of the client device and the acquiring switch using a communication network.

For the purpose of this example, it will be assumed that the client device may be a suitably configured mobile device such as a smart phone. However, the customer may alternatively use a client device in the form of a stationary computing device such as a suitably programmed PC. The client device will typically execute application software for enabling communication with the application server and enabling functionalities of the method. However, in alternative embodiments the customer may use a web interface provided via a web browser executed on the client device in order to interface with the application server.

For the purpose of this example, it is assumed that the customer is a registered user of the application software and that the application software is appropriately configured for use with the method. Furthermore, it is assumed that the customer has a payment instrument capable of being used to perform financial transactions with the ATM (such as a debit card or a credit card) and that this has been associated with the customer's registration.

The acquiring switch will typically facilitate the operation of the associated plurality of ATMs, being primarily responsible for switching and driving of transactions using each associated ATM. The acquiring switch may facilitate the operation of the plurality of ATMs on an ATM network operated by an acquiring financial institution.

The method commences at step 100 when a withdrawal query request is received from the client device. The withdrawal query request includes a desired withdrawal amount in desired currency denominations, which may be input by the customer using the client device. The withdrawal query request may be received in response to the customer interacting with a graphical user interface provided by the application software executed on the client device, to select an option to request that a withdrawal query be performed.

In some examples the customer may select a particular one of the plurality of ATMs for the withdrawal query, in which case the withdrawal query request may include an indication of the customer selected ATM, so that the withdrawal query may be performed in relation to the customer selected ATM. Typically the ATMs available for selection by the customer will only be ATMs that will accept the customer's payment instrument associated with their registration to allow financial transactions to be performed using the ATMs. In some implementations, the ATMs available for selection may be nearby ATMs that are determined based on proximity of the ATMs to a location of the client device. In some implementations, the ATMs available for selection may be nearby ATMs that are determined based on availability of the desired withdrawal amount in desired currency denominations. In some implementations, an indication of the location of the client device may be included in the withdrawal query request to allow the application server to determine nearby ATMs for the withdrawal query, and the withdrawal query may performed in relation to one or more of the nearby ATMs.

In step 110, one or more security checks are performed based at least in part on the withdrawal query message. For instance, the withdrawal query message may be used to check that the desired withdrawal amount does not exceed a maximum withdrawal limit, or the withdrawal query message may be used to check that the customer has not exceeded a maximum query request limit for a predetermined period, such as a day. The security checks may be performed to help to prevent the use of the withdrawal query functionality to determine the amount of cash available in an ATM for assessing whether it is a viable target for theft or fraudulent use. The security checks are typically performed by the application server and may additionally involve accessing a log of the customer's previous withdrawal queries along with other stored customer details in order to allow the security checks to be performed.

In the event that the one or more security checks are passed, step 120 involves providing a status query message to the acquiring switch. In some implementations, the status query message may be generated by the application server to include identification details of one or more ATMs for the status query, which may be a customer selected ATM or a plurality of nearby ATMs determined based on the location of the client device.

Upon receipt of the status query message, the acquiring switch may access (for example, in a polling manner) status information that is maintained by the acquiring switch for each of the plurality of ATMs associated with the acquiring switch, to determine the current status of one or more ATMs to which the status query message relates.

The acquiring switch may be configured to receive, from each of the plurality of ATMs, periodic status messages indicative of the operational status of the ATM along with counter messages whenever the ATM dispenses cash or is loaded with additional cash by a Cash Replenishment Agency (CRA) or the like. These messages may be used to update the status information maintained by the acquiring switch for the ATM.

In some implementations, the acquiring switch may communicate with the one or more ATM to determine the current status in response to the status query message, however this may not be required if the status information maintained by the acquiring switch for the ATM is updated appropriately.

In any event, the acquiring switch will generate a status query response indicative of a current status of the one or more ATMs, which is received by the application server at step 130. For example, the status query response may include indications of the operational status and an available cash balance with a breakdown of currency denominations of each of the one or more ATMs.

Step 140 of the method then involves determining whether the desired withdrawal amount in desired currency denominations can be withdrawn from the one or more ATMs based on the status query response. The determination may include the application server analysing the status query response to determine whether each of the one or more ATMs is inoperative or currently in a “cash out” state, which may be set once the ATM has dispensed cash to the point that the amount of cash loaded in the ATM falls below a minimum threshold. In the event an ATM is operational and is not in a “cash out” state, the application may compare the desired withdrawal amount with the available cash balance and denominations of the ATM to determine whether sufficient cash is available for withdrawal using that ATM.

Finally, at step 150, the application server provides, to the client device, an indication of whether the desired withdrawal amount in desired currency denominations can be withdrawn using at least one of the one or more ATMs. This indication may be presented to the customer on a display of the client device using a graphical user interface of the application software executed on the client device. In the case of a withdrawal query performed for a particular customer selected ATM, the indication may relate to that ATM only. In the case of a withdrawal query based on the location of the client device, the indication may relate to a plurality of nearby ATMs. Moreover, in the case of a withdrawal query based on availability of the desired withdrawal amount in desired currency denominations, the indication may relate to a plurality of nearby ATMs.

If it is determined in step 140 that the desired withdrawal amount in desired currency denominations is indeed available, then the indication may simply indicate that the customer selected ATM or at least one of a plurality of nearby ATMs are available for use for the withdrawal. On the other hand, if it is determined in step 140 that the desired withdrawal amount cannot be withdrawn from any of the one or more ATMs, such as due to inoperability or insufficient funds, the indication may indicate that the ATM is unavailable and may optionally provide a reason why the ATM is unavailable.

The response to the status query request will generally be limited to an indication of whether the desired withdrawal amount can be withdrawn from the one or more ATMs, and this should not provide any details of the total available cash balance of the ATMs, since such information could allow potential thieves to target an ATM for theft if it is loaded with a sufficiently large amount of cash.

In any event, it will be appreciated that the above described method can provide a customer with a convenient way of remotely determining whether an ATM is available for a desired withdrawal in desired currency denominations before physically travelling to the location of the ATM. This capability can therefore avoid the potential inconvenience of a customer wasting time and effort going to an ATM only to discover that the ATM is inoperative or is not loaded with sufficient cash.

However, the security checks performed in step 110 and the limited indication of whether the desired withdrawal amount can be withdrawn at step 150 play an important role in ensuring the security of the method and preventing abuse of the withdrawal query functionality by potential thieves.

Optional implementation features of the method will now be described.

In some examples, the one or more security checks may include checking that the desired withdrawal amount does not exceed a maximum withdrawal limit for the customer in a predetermined period. The application server may retrieve the maximum withdrawal limit for the customer from customer information associated with the customer registration, which may be stored in a database of the application server.

Additionally or alternatively, the one or more security checks may include checking that the withdrawal query request does not exceed a maximum query request limit in a predetermined period. In this regard, the application server may maintain a log of withdrawal queries requested by the customer and determine whether one more withdrawal query will take the number of status queries in the predetermined period over the maximum query request limit.

The above mentioned predetermined periods will typically be one day, but may be any period for which it may be desirable to impose limits over the use of the withdrawal query functionality, for security purposes or otherwise.

In some implementations, the method may include, in the event that at least one of the one or more security checks is not passed, providing, to the client device, a notification that the withdrawal query request has been denied. This notification can then be presented on the display of the client device. This notification may optionally provide a reason why the withdrawal query request has been denied. For instance, if the withdrawal query request was only denied due to the desired withdrawal amount being in excess of a daily maximum withdrawal limit, the customer may receive an indication to that effect, and this may optionally include confirmation of the maximum withdrawal limit to allow the customer to request a new withdrawal query request that does not exceed that limit.

As mentioned above, the status query response may be indicative of an operational status and an available cash balance (amount and breakdown of currency denomination) of one or more ATMs. In some examples, the method may include having the acquiring switch receive periodic status messages from each of the associated plurality of ATMs. This may allow the acquiring switch to maintain a record of the operational status of each ATM and provide an indication of the operational status as part of the status query response.

Similarly, the method may include having the acquiring switch receive counter messages from each of the associated plurality of ATMs, to allow the acquiring switch to maintain a record of the available cash balance (amount and breakdown of currency denomination) of each ATM and provide an indication of the available cash balance as part of the status query response. In some implementations, the acquiring switch may maintain the record of the available cash balance of each ATM by updating the available cash balance in response to counter messages indicative of any amount of cash being loaded into the ATM or any amount of cash being dispensed from the ATM.

It will be appreciated that the above functionality of the acquiring switch maintaining a record of the available cash balance and breakdown of currency denomination for each ATM may be provided as an existing capability of the acquiring switch in its role of facilitating transactions using the ATMs associated with the acquiring switch.

In this regard, it will be appreciated that an ATM will typically include one or more cassettes, wherein cash is loaded into each of the one or more cassettes. The one or more cassettes may be classified into categories for identifying the cash loaded therein. Each category of cassette may be loaded with a specific denomination of currency according to rules known to the acquiring switch. As cash is loaded into or dispensed from the cassettes of the ATM, a counter will be updated for each cassette and this can be used to determine the amount of cash in each cassette based on the denomination of currency.

The above mentioned counter messages may be sent from the ATM to the acquiring switch whenever the counter is updated to allow the acquiring switch to keep an up to date record of the amount of cash and breakdown of currency denomination in the ATM. Accordingly, the total available cash balance for the ATM can be maintained by the acquiring switch by updating the available cash balance in accordance with any received counter messages for the cassettes of the ATM, with regard to the known rules regarding the denomination of currency loaded in each cassette.

During normal operation, the ATM will continue to dispense cash as customer withdrawal transactions are performed, until the amount of cash loaded in the ATM falls below a minimum threshold value. The ATM will then enter a “cash out” state and will stop dispensing cash to customers. Typically, when this occurs the ATM will provide a status message to the acquiring switch to indicate that the acquiring switch that the ATM has entered the “cash out” state. This can be used by the acquiring switch to arrange for a cash replenishment agency to reload the ATM with cash. In the context of the above described method, the operational status that is maintained by the acquiring switch for the ATM may be updated to reflect the “cash out” state when this is indicated in a status message.

In view of the above, it will be appreciated that some embodiments of the method may include determining that the desired withdrawal amount cannot be withdrawn from an ATM when the operational status of the ATM indicates that the ATM is in an inoperative state or in a “cash out” state, or otherwise when the desired withdrawal amount exceeds the available cash balance of the ATM.

In the event of the application server making a determination that the desired withdrawal amount in desired currency denominations can be withdrawn from at least one of the one or more ATMs, the application server may provide, to the client device, an indication confirming that the desired withdrawal amount can be withdrawn. Alternatively, in the event of the application server making a determination that the desired withdrawal amount cannot be withdrawn from any of the one or more ATMs, the application server may provide, to the client device, an indication of why the desired withdrawal amount cannot be withdrawn.

As mentioned above, in some embodiments the withdrawal query request may include an indication of a customer selected ATM. Accordingly, the status query message and the status query response may relate to the user selected ATM. Alternatively, the withdrawal query request may include an indication of a location of the client device, In this case the method may include determining one or more nearby ATMs based on the location of the client device, such that the status query message and the status query response may relate to the one or more nearby ATMs.

It will be appreciated that an apparatus may be provided for allowing a customer to perform a withdrawal query to determine whether a desired withdrawal amount can be withdrawn using an ATM in accordance with the method discussed above. The apparatus may include the one or more electronic processing devices (i.e. the application server) and may be configured to perform steps as discussed above with regard to FIG. 1. The one or more electronic processing devices will typically be configured to communicate with the client device and the acquiring switch using one or more communications networks. It should be appreciated that different communications networks may be used in this regard depending on the implementation.

A method for allowing a customer to perform a withdrawal query to determine whether a desired withdrawal amount in desired currency denominations can be withdrawn using ATM may also be defined from the perspective of the client device. In this regard, the method performed using the client device may involve the following steps. First, a request to perform a withdrawal query may be obtained from the customer, followed by an indication of a desired withdrawal amount in desired currency denominations. Then the client device may generate a withdrawal query request including the desired withdrawal amount. This withdrawal query request may be provided to an application server, to thereby cause the application server to determine whether the desired withdrawal amount in desired currency denominations can be withdrawn from one or more ATMs, as discussed above. The client device may then receive, from the application server, an indication of whether the desired withdrawal amount can be withdrawn using at least one of the one or more ATMs. Finally the indication may be presented to the customer using a display of the client device.

In some implementations, the method may include having the application server perform one or more security checks based at least in part on the withdrawal query request, and in the event that at least one of the one or more security checks is not passed, the client device may receive, from the application server, a notification that the withdrawal query request has been denied. The client device may in turn present this to the customer using the display of the client device.

As discussed above, the client device may also present, on the display device, indications for either confirming that the desired withdrawal amount can be withdrawn or providing a reason as to why the desired withdrawal amount cannot be withdrawn.

In some implementations, the method may be extended to allow the customer to make a selection of an ATM from a plurality of ATMs. In this regard, the client device may obtain the selection of the ATM from the customer in response to the customer interacting with a graphical user interface of the application software executed on the client device. In response to obtaining a customer selection of an ATM, the client device may generate the withdrawal query request including an indication of the customer selected ATM and ultimately receive an indication of whether the desired withdrawal amount in desired currency denominations can be withdrawn using the customer selected ATM.

In some examples, the customer selection of the ATM may involve the use of a map interface presented on the client device. For instance, the method may include the client device presenting indications of the plurality of ATMs in corresponding locations on a map interface using the display, and then obtaining, from the customer, the selection of the ATM using the map interface.

In some implementations, the map interface may be presented on a touch screen interface of the client device, for instance when the client device is a touch enabled smart phone or tablet device. This can provide the customer with the ability to utilise touch gestures to interact with the map interface, such as zooming in and out or panning the map view to explore the locations of the plurality of the ATMs.

In one particular example, the map interface may utilise the location of the client device so that a plurality of nearby ATMs can be indicated in the map interface. In particular, the method may include steps of determining a location of the client device, determining a plurality of nearby ATMs by selecting ATMs that are located within a distance threshold of the location of the client device, and then presenting the indications of the nearby ATMs in corresponding locations on the map interface relative to the location of the client device.

In other examples, the method may not specifically require a customer selection of an ATM as part of the withdrawal query. For instance, in one embodiment, the method may include determining a location of the client device, generating the withdrawal query request including an indication of the location of the client device to allow the application server to determine one or more nearby ATMs based on the location of the client device, and ultimately receiving an indication of whether the desired withdrawal amount in desired currency denominations can be withdrawn using the one or more nearby ATMs. The indication of whether the desired withdrawal amount in desired currency denominations can be withdrawn using the one or more nearby ATMs may be presented using a map interface. This may provide the customer with a convenient overview of which nearby ATMs may be available to the customer for the desired withdrawal.

The map interface may utilise a commercially available mapping application program interface (API) to integrate the ATM locations with other mapping data such as streets and other geographical points of interest. The map interface may also be used to enable further useful location-based functionalities such as the ability to provide a distance to travel to a selected ATM, a time to travel to a selected ATM accounting for current traffic conditions which may be available through the mapping API, or turn-by-turn directions to allow the customer to navigate to the ATM from their current location.

However, it should be understood that the use of a map interface is not essential, and an ATM may alternatively be selected by the customer from a list of available ATMs or in some implementations the closest available ATM may be automatically selected to avoid the need for a manual selection by the customer.

In view of the above, it will be appreciated that a client device may be provided for allowing a customer to perform a withdrawal query to determine whether a desired withdrawal amount can be withdrawn using an ATM, by configuring the client device to perform the steps discussed above from the perspective of the client device. Such a configuration will typically be enabled by the application software executed by the client device, or by a suitably designed web interface.

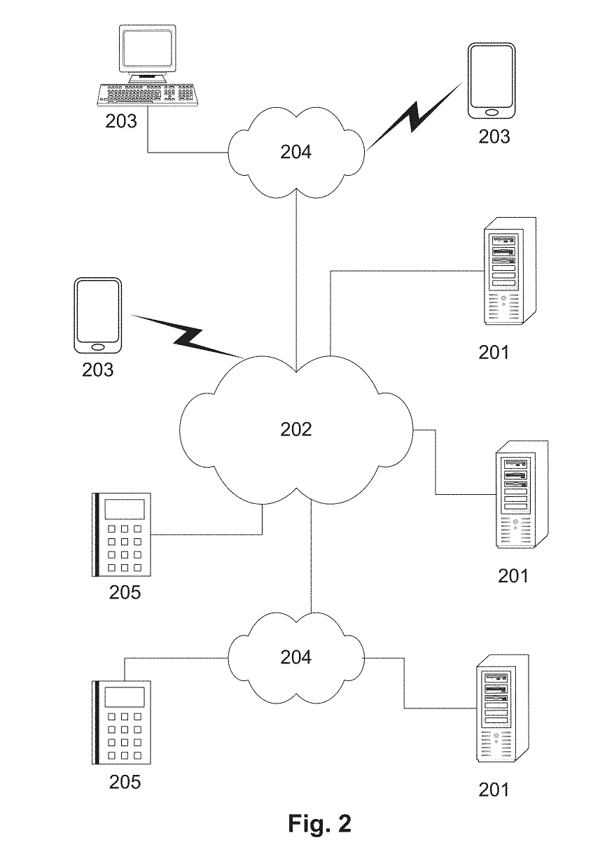

In one example, the process is performed by one or more processing systems operating as part of a distributed architecture, an example of which will now be described with reference to FIG. 2.

In this example, the arrangement includes a number of processing systems 201, 203 and ATMs 205 interconnected via one or more communications networks, such as the Internet 202, and/or a number of local area networks (LANs) 204. It will be appreciated that the configuration of the networks 202, 204 are for the purpose of example only, and in practice the processing systems 201, 203 and ATMs 205 can communicate via any appropriate mechanism, such as via wired or wireless connections, including, but not limited to mobile networks, private networks, such as an 802.11 networks, the Internet, LANs, WANs, or the like, as well as via direct or point-to-point connections, such as Bluetooth, or the like.

The nature of the processing systems 201, 203 and their functionality will vary depending on their particular requirements. In one particular example, the processing systems 201, 203 represent servers (such as the application server and the acquiring switch) and clients (such as the client device), although this is not essential and is used primarily for the purpose of illustration.

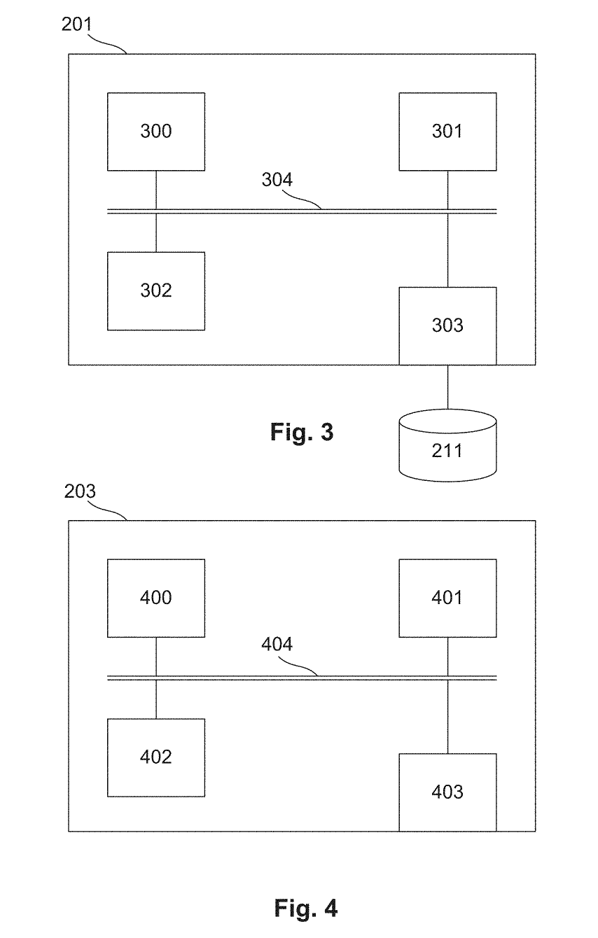

An example of a suitable processing system 201 is shown in FIG. 3. In this example, the processing system 201 includes an electronic processing device, such as at least one microprocessor 300, a memory 301, an optional input/output device 302, such as a keyboard and/or display, and an external interface 303, interconnected via a bus 304 as shown. In this example the external interface 303 can be utilised for connecting the processing system 201 to peripheral devices, such as the communications networks 202, 204, databases 211, other storage devices, or the like. Although a single external interface 303 is shown, this is for the purpose of example only, and in practice multiple interfaces using various methods (e.g. Ethernet, serial, USB, wireless or the like) may be provided.

In use, the microprocessor 300 executes instructions in the form of applications software stored in the memory 301 to perform required processes, such as communicating with other processing systems 201, 203, and in the case of the acquiring switch, with associated ATMs 205. Thus, actions performed by a processing system 201 are performed by the processor 300 in accordance with instructions stored as applications software in the memory 301 and/or input commands received via the I/O device 302, or commands received from other processing systems 201, 203. The applications software may include one or more software modules, and may be executed in a suitable execution environment, such as an operating system environment, or the like.

Accordingly, it will be appreciated that the processing systems 201 may be formed from any suitable processing system, such as a suitably programmed computer system, PC, web server, network server, or the like. In one particular example, the processing system 201 is a standard processing system such as a 32-bit or 64-bit Intel Architecture based processing system, which executes software applications stored on non-volatile (e.g., hard disk) storage, although this is not essential. However, it will also be understood that the processing systems 201 could be or could include any electronic processing device such as a microprocessor, microchip processor, logic gate configuration, firmware optionally associated with implementing logic such as an FPGA (Field Programmable Gate Array), or any other electronic device, system or arrangement.

As shown in FIG. 4, in one example, the processing systems 203 include an electronic processing device, such as at least one microprocessor 400, a memory 401, an input/output device 402, such as a keyboard and/or display, and an external interface 403, interconnected via a bus 404 as shown. In this example the external interface 403 can be utilised for connecting the processing system 203 to peripheral devices, such as the communications networks 202, 204, databases, other storage devices, or the like. Although a single external interface 403 is shown, this is for the purpose of example only, and in practice multiple interfaces using various methods (e.g. Ethernet, serial, USB, wireless or the like) may be provided.

In use, the microprocessor 400 executes instructions in the form of applications software stored in the memory 401 to perform required processes, for example to allow communication with other processing systems 201, 203. Thus, actions performed by a processing system 203 are performed by the processor 401 in accordance with instructions stored as applications software in the memory 402 and/or input commands received from a user via the I/O device 403. The applications software may include one or more software modules, and may be executed in a suitable execution environment, such as an operating system environment, or the like.

Accordingly, it will be appreciated that the processing systems 203 may be formed from any suitable processing system, such as a suitably programmed PC, Internet terminal, lap-top, hand-held PC, smart phone, PDA, tablet, or the like. Thus, in one example, the processing system 203 is a standard processing system such as a 32-bit or 64-bit Intel Architecture based processing system, which executes software applications stored on non-volatile (e.g., hard disk) storage, although this is not essential. However, it will also be understood that the processing systems 203 can be any electronic processing device such as a microprocessor, microchip processor, logic gate configuration, firmware optionally associated with implementing logic such as an FPGA (Field Programmable Gate Array), or any other electronic device, system or arrangement.

It will also be noted that whilst the processing systems 201, 203 are shown as single entities, it will be appreciated that this is not essential, and instead one or more of the processing systems 201, 203 can be distributed over geographically separate locations, for example by using processing systems provided as part of a cloud based environment.

For the purpose of the following detailed examples, it is assumed that the client devices used by the customers will be provided by processing systems 203 executing suitable application software. Furthermore, it is assumed that the client devices of the customers include a display capable of presenting a graphical user interface and have a suitable user input capability such as a touch screen for receiving touch commands input by the customer.

The process may be facilitated by one or more of the processing systems 201, acting as application servers. The acquiring switch may be provided by one or more other processing systems 201 which are capable of communicating with the ATMs 205.

As depicted in FIG. 2, the processing systems 201 acting as application servers and/or acquiring switches and the processing systems 203 acting as client devices may be connected to communications networks 202, 204 in different configurations, to allow communication between the different processing systems 201, 203 via the Internet 202. Moreover, the ATMs 205 may be connected directly to the Internet 202 or to a separate communications network 204, such as a specialised ATM network.

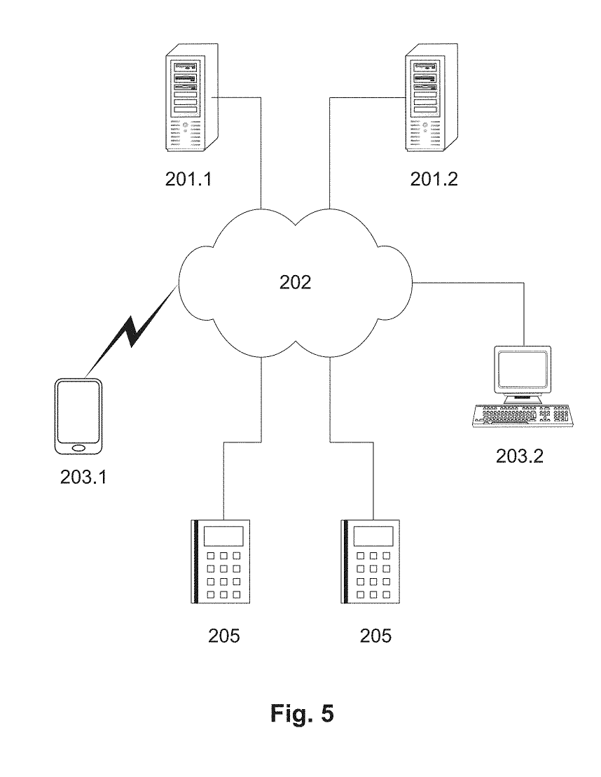

A particular example of a system configuration for allowing a customer to perform a withdrawal query to determine whether a desired withdrawal amount in desired currency denominations can be withdrawn using an ATM, which is assumed to be used in the following detailed examples, will now be described with regard to FIG. 5.

In this example, the customer uses a client device 203.1 in the form of a smart phone which may include a touch screen display for presenting a graphical user interface and allowing the customer to interact with the graphical user interface by inputting touch commands. Typically the client device 203.1 will be configured to connect to the Internet 202. In this case the client device 203.1 of the customer wirelessly connects to the Internet 202 and has a data plan on a mobile network for allowing the consumption of mobile data via the Internet 202. The client device 203.1 will typically execute application software for enabling the functionalities required to perform the method. The customer will interact with their client device 203.1 to open the application software for requesting a withdrawal query and to receive responses to the withdrawal query request.

FIG. 5 also shows an alternative client device 203.2 in the form of a personal computer, which may be physically connected to the Internet 202 via an Internet Service Provider using a modem. In this case, the customer may use the client device 203.2 to access a web interface via a web browser, whereby the web interface facilitates the functionalities of the method. However, the following examples will generally assume that the smart phone version of the client device 203.1 will be used.

In this example, the system includes an application server 201.1 which may be configured to send and receive information to and from client devices 203.1, 203.2 to facilitate the status query process. The client devices 203.1, 203.2 will usually be connected to the application server 201.1 via the Internet 202. The application server 201.1 may include a database 211 for storing registered user details such as details of customer accounts, and may also store other customer information for use with the method, such as a log of previous withdrawal queries or details of maximum withdrawal limits for associated payment instruments of the customer.

The application server 201.1 will be configured to receive the withdrawal query request from the client device 203.1, and provide an indication of whether the desired withdrawal amount in desired currency denominations can be withdrawn to the client device 203.1. The application server 201.1 may also be configured to provide notifications to the client device 203.1, such as in the event that at least one of the security checks performed based on the withdrawal query request are not passed. The application server 201.1 may also be configured to send/receive other information to/from the client devices 203.1, such as for the registration of new customers or merchants or to enable ongoing configuration changes by the customers or merchants.

In addition, the application server 201.1 will communicate with an acquirer switch 201.2 which is responsible for facilitating the operation of a number of associated ATMs 205. The application server 201.1 will thus be configured to provide the status query message to the acquiring switch 201.2 and receive the status query response from the acquiring switch 201.2. In this example, the communications between the application server 201.1 and the acquirer switch 201.2 takes place via the Internet 202. For simplicity FIG. 5 indicates that the acquirer switch 201.2 and the ATMs 205 also communicate via the Internet 202, although it should be appreciated that some implementations may involve the use of a specialised ATM network for facilitating communications between the acquirer switch 201.2 and the ATMs 205.

The application software executed by each client device 203.1, 203.2 will typically be configured to facilitate these and other information transfers. The customer or merchant may interact with the application server via a graphical user interface, or the like, presented on their respective processing systems 203.1, 203.2, such as via the application software or optionally via a browser application that displays webpages hosted by the application server 201.1.

However, it will be appreciated that the above described configuration assumed for the purpose of the following examples is not essential, and numerous other configurations may be used. It will also be appreciated that the partitioning of functionality between the processing systems 201, 203 may vary, depending on the particular implementation.

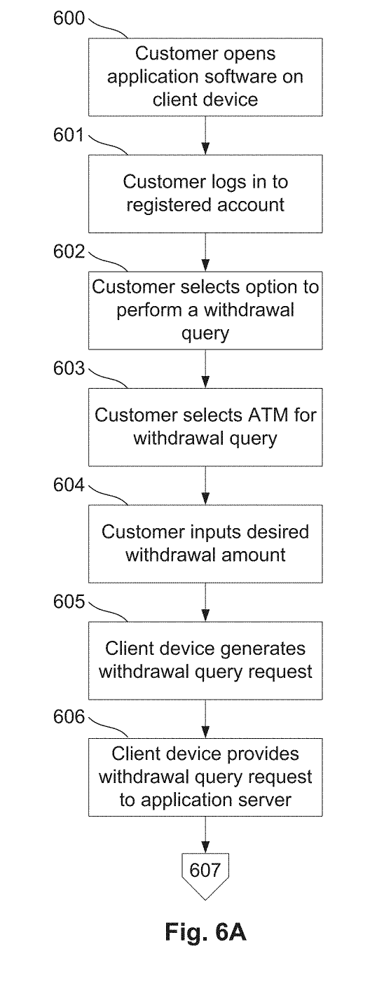

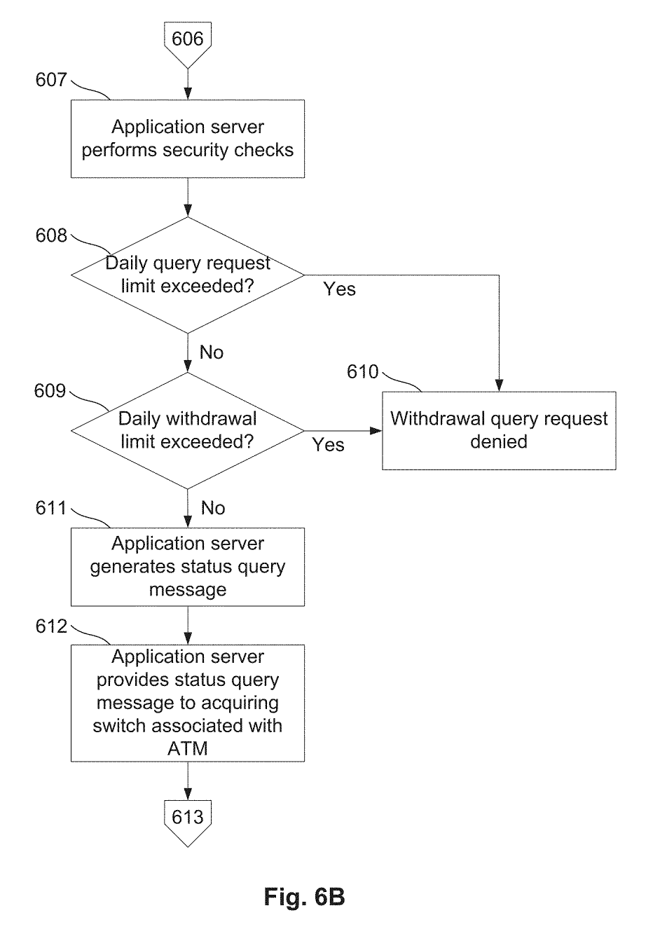

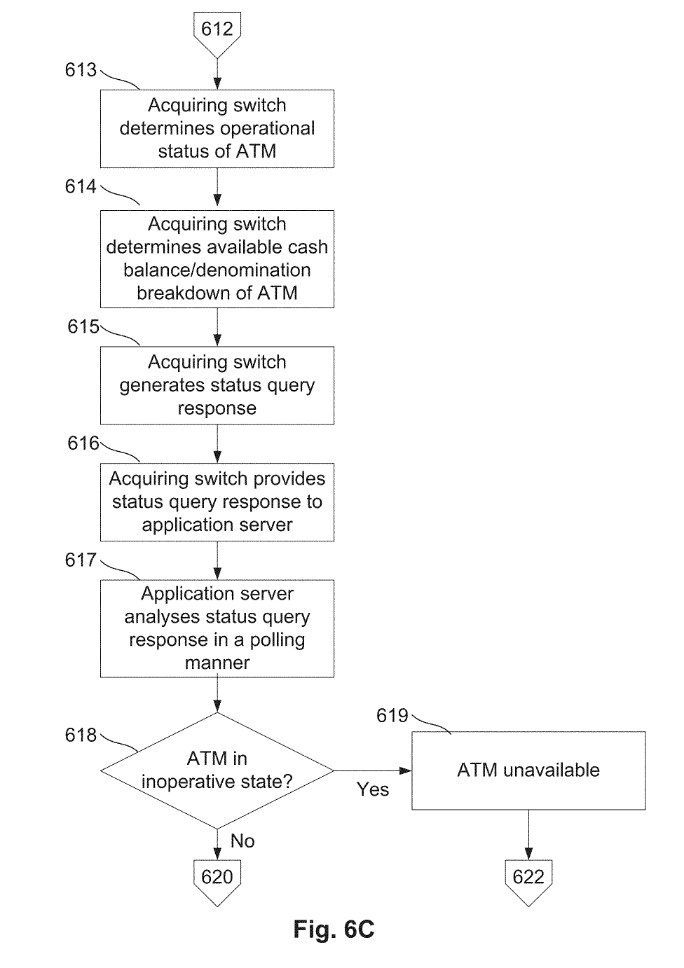

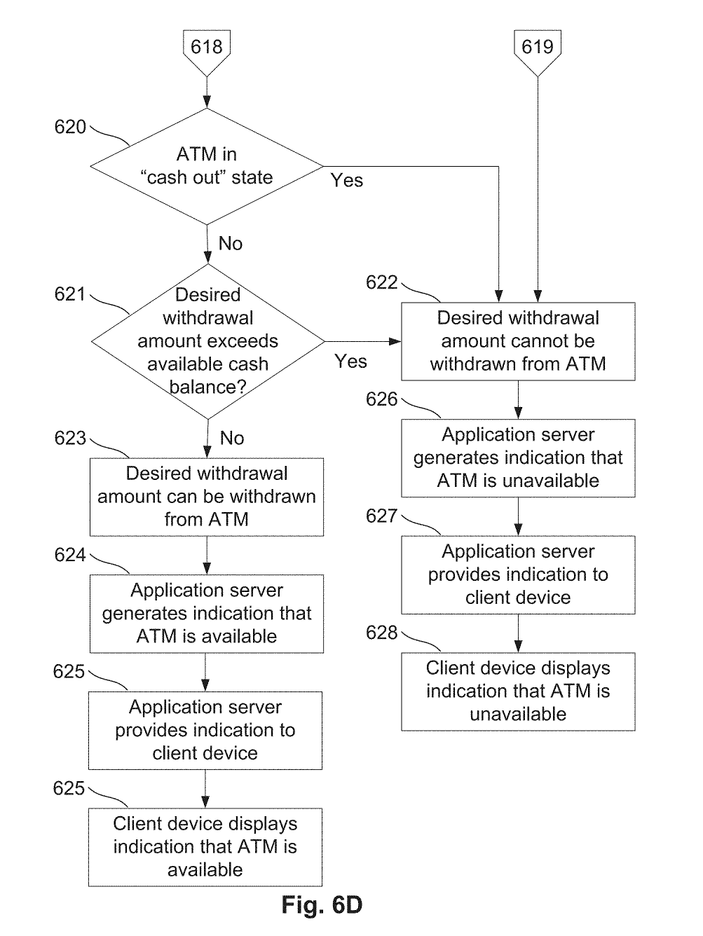

A detailed example of a method of a customer performing a withdrawal query using the above discussed techniques will now be described with regard to the flow chart of FIGS. 6A to 6D. The withdrawal query includes a request for a desired withdrawal amount in desired currency denominations.

This example assumes that the customer's client device 203.1 is a smartphone having a touch screen display, data connectivity and having a suitable version of the application software for facilitating the process installed, as discussed above. The customer is assumed to be already registered as a user of the application software, and is also assumed to have a mobile wallet associated with one or more payment instruments (credit cards, debit cards) capable of making cash withdrawals using an ATM as mentioned earlier. Typically, when the customer initially registers as a user, the customer will set up the application software by connecting their mobile wallet to the application software.

In step 600, the customer will open the application software on their client device 203.1 to initiate the withdrawal query process. The customer will typically log in to a registered user account at step 601 to thereby verify the customer's identity. Once the customer has logged in, at step 602 the customer will select an option to perform a withdrawal query in the application software.

In this example, the application software will prompt the customer to select an ATM 205 for the withdrawal query, and the customer will make a selection in step 603. The selection may involve selecting the ATM 205 from a list or from a map interface, which may show a plurality of nearby ATMs 205 determined based on the location of the client device. In some instances the customer may be presented with details of an ATM 205 that is determined to be the closest to the location of the client device and the customer selection may simply involve the customer confirming that the withdrawal request can be made for the closest ATM 205.

The ATM selection may involve communications between the client device 203.1 and the application server 203.2 to allow the application server 203.2 to provide details of ATMs 205 available for selection by the customer.

In any event, upon selecting the ATM 205, at step 604 the customer will then input a desired withdrawal amount in desired currency denominations for the withdrawal query. This may involve the customer manually inputting a value of currency, selecting an amount from a set of common withdrawal amounts, selecting multiples of cash denominations commonly loaded in ATMs 205 in the region, or any other suitable technique.

At step 605 the client device 203.1 will then generate a withdrawal query request including the desired withdrawal amount along with an indication of the selected ATM 205. This withdrawal query request will then be provided to the application server 201.1 associated with the selected ATM 205 at step 606 via a communications network such as the Internet 202.

Next, at step 607, the application sever 201.1 will perform security checks on based on the received withdrawal query request. For example, at step 608, the application server 201.1 will check whether the daily query request limit for the customer has been exceeded. This may involve accessing a log of previous withdrawal query requests for the customer which may be maintained by the application sever 201.1. In one example, if the daily query request limit is three, then the check at step 608 will be passed if the total number of withdrawal query requests for the customer on the same day, including the current withdrawal query request, is three or less. If the check at step 608 is passed, then at step 609 a further check will be performed to ensure the desired withdrawal amount included in the withdrawal query request does not exceed the daily withdrawal limit for the customer.

If either of the checks at steps 608 and 609 is not passed, then the withdrawal query request will be denied at step 610 and the application server 201.1 may cause a notification to be provided to the client device 203.1 to inform the customer of the denial. This may provide reasons for the denial, which might allow the customer to re-attempt the withdrawal query in certain circumstances, such as when the withdrawal limit was exceeded.

However, in the event that both checks at step 608 and 609 are passed, then the application server 201.1 will proceed to generate a status query message at step 611. The status query message will typically include an identification of the ATM for the status query. The status query message will in turn be provided to the acquiring switch 201.2 associated with the customer selected ATM 205 at step 612, again via a communications network such as the Internet 202.

At step 613, upon receipt of the status query message the acquiring switch 201.2 will determine the operational status of the ATM 205 identified in the status query. As mentioned above, the acquiring switch 201.2 may maintain a record of the operational status of each ATM which is updated based on periodic status messages received from the ATM 205, such that the acquiring switch 201.2 may be able to determine the operational status of the ATM 205 in a polling manner without needing to contact the ATM 205 in response to the status query request. However, in some implementations, the acquiring switch 201.2 may communicate with the ATM 205 to ensure an up to date operational status is obtained.

At step 614, the acquiring switch 201.2 will also determine the available cash balance and breakdown of currency denomination of the ATM 205. This may be based on a record of the available cash balance of each ATM 205 that is maintained by the acquiring switch 201.2 as discussed above, or may alternatively involve directly communicating with the ATM 205 to obtain an up to date value of the available cash balance/denomination breakdown of the ATM 205.

In any event, having determined the operational status and available cash balance/denomination breakdown of the ATM 205, at step 615 the acquiring switch 201.2 will then generate a status query response at step 615 indicative of the operational status and available cash balance/denomination breakdown. This status query response will then be provided to the application server 201.1 at step 616.

The application server 201.1 will then analyse the status query response (for example, in a polling manner) at step 617 to determine whether the customer can made the desired withdrawal using the ATM 205. At step 618, the application server 201.1 will determine whether the status query response indicates that the ATM 205 is in an inoperative state. If so, the application server 201.1 will determine that the ATM 205 is unavailable for use at 619 and can therefore instantly conclude that the desired withdrawal amount cannot be withdrawn from the ATM 205 as shown at step 622, without requiring any other analysis of the status query response.

However, if the ATM 205 is determined to be operational, then at step 620 the application server 201.1 will proceed to determine whether the ATM 205 is in a “cash out” state. If the ATM is in the “cash out” state, the application server 201.1 will conclude that the desired withdrawal amount cannot be withdrawn from the ATM 205 as shown at step 622 without needing to compare the desired withdrawal amount with the available cash balance. But if the ATM is not in the “cash out” state, then at step 621 the application server 201.1 will check whether the desired withdrawal amount in desired currency denominations associated with the withdrawal query request exceeds the available cash balance of the ATM 205.

If the available cash balance is exceeded by the desired withdrawal amount, then the application server 201.1 will conclude that the desired withdrawal amount cannot be withdrawn from the ATM 205 at step 622 in a similar manner as per the inoperative ATM 205 or “cash out” scenarios mentioned above.

Assuming the desired withdrawal amount does not exceed the available cash balance of the ATM 205, and the desired currency denominations are available, the application server 201.1 will determine that the withdrawal amount can be withdrawn from the ATM at step 623 and will subsequently generate an indication that the ATM is available for use by the customer at step 624. This indication will be provided to the client device 203.1 at step 625. The client device 203.1 will then display an indication that will confirm to the customer that the customer selected ATM 205 is indeed available for use by the customer to withdraw the desired withdrawal amount in desired currency denominations. The customer can then travel to the customer selected ATM 205 with confidence that the ATM 205 will be operational and will be loaded with sufficient cash for the withdrawal.

However, if the application server 201.1 concludes that the desired withdrawal amount cannot be withdrawn from the ATM 205 at step 622 for any reason, then at step 626 the application server 201.1 will instead generate an indication that the ATM 205 is unavailable. This indication will be provided to the client device 203.1 at step 627 to allow the client device to display an indication to inform the customer that the customer selected ATM 205 cannot be used to make the desired withdrawal. In this case the customer may then be able to attempt another withdrawal query, assuming the client has not reached the daily query request limit.

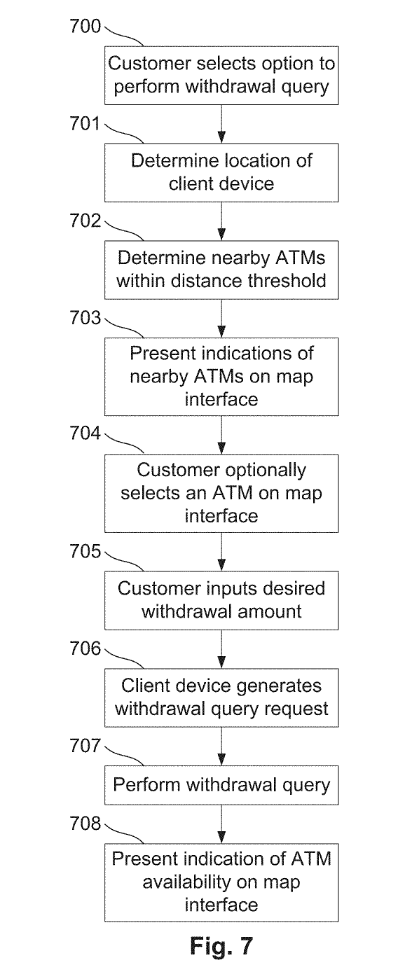

As mentioned above, in some implementations a map interface may be used to facilitate the withdrawal query process, and accordingly, an example of a method of a customer performing a withdrawal query using a map interface will now be described with regard to the flow chart of FIG. 7. The withdrawal query includes a request for a desired withdrawal amount in desired currency denominations.

It is noted that this example expands upon steps 602 to 605 of the previous example in which the customer initiates the withdrawal query. Accordingly, it is assumed that the customer has already opened the application software of the client device 203.1 and has logged into the registered account as per steps 600 and 601 of the previous example.

The example of FIG. 7 begins at step 700 (which corresponds to step 602 of the previous example) in which the customer selects an option to perform a withdrawal query. In this example, the client device 203.1 will determine the location of the client device 203.1 at step 701. Accordingly, it will be appreciated that the client device 203.1 used in this example should have location capabilities for allowing the client device location to be determined. For example, the client device 203.1 may be in the form of a smartphone, which includes a GPS receiver for allowing the location of the client device 203.1 to be determined. However, in alternative examples where a dedicated location sensor such as a GPS receiver is not available, the client device 203.1 may able to determine an approximate location using cell tower triangulation or any other suitable location capability of the client device 203.1.

In any event, at step 702 the location of the client device 203.1 will then be used to determine one or more nearby ATMs 205 within a distance threshold of the client device location. The distance threshold may be a predetermined value or the customer may be able to specify this as part of the withdrawal query, based on a distance the customer may be willing to travel to visit an ATM 205. In practice the step of determining the one or more nearby ATMs 205 may involve the client device 203.1 communicating with the application server 201.1 to obtain details of ATMs 205 in the region or to have the application server 201.1 determine the one or more nearby ATMs 205 and return the results to the client device 203.1

At step 703, indications of the nearby ATMs 205 will be presented on a map interface on the client device 203.1. As mentioned above, the map interface may utilise a commercially available mapping API to provide the ATM 205 locations in the context of additional mapping data such as streets and other geographical points of interest.

At step 704 the customer may optionally select an ATM 205 n the map interface, although this is not essential and in some examples the method may proceed directly to prompt the customer for a desired withdrawal amount, which can be input by the customer at step 705 in a similar manner as per step 604 in the previous example.

At step 706, the client device 203.1 will then generate the withdrawal query request including the desired withdrawal amount in desired currency denominations, which may or may not include an indication of a customer selected ATM 205. If the customer did not select at ATM 205, the withdrawal query request may be generated for all of the nearby ATMs 205 determined based on the location of the client device 203.1 at step 702.

Then, as indicated at step 707, the withdrawal query process may be performed generally as described above, although this may be extended to determine the operational status and available cash balance for multiple nearby ATMs 205 as opposed to a single customer selected ATM 205 as in the previous example.

In this example, the outcome of the withdrawal query may also be indicated to the customer using the map interface as indicated at step 708. For instance, an indication of the availability of ATMs 205 for use in withdrawing the desired withdrawal amount can be included in the map interface.

This may be particularly useful in the event that the withdrawal query is performed for multiple nearby ATMs 205. In such cases the application server 201.1 may provide an indication of whether the desired withdrawal amount in desired currency denominations can be withdrawn for each of the nearby ATMs 205 simultaneously. This can prevent the need for the customer to repeat the process in the event a customer selected ATM 205 is determined to be unavailable in a withdrawal query for a single ATM.

In any event, it will be appreciated that the above techniques provide a convenient way for a customer to perform a withdrawal query to determine whether a desired withdrawal amount in desired currency denominations can be withdrawn from an ATM in the vicinity of the customer, but with security measures in place to prevent the techniques from being abused by potential thieves. Using the methods discussed above, the customer can gain confidence that a desired withdrawal from an ATM will be possible before taking the time and effort to physically travel to the ATM to perform the withdrawal transaction.

Throughout this specification and claims which follow, unless the context requires otherwise, the word “comprise”, and variations such as “comprises” or “comprising”, will be understood to imply the inclusion of a stated integer or group of integers or steps but not the exclusion of any other integer or group of integers.

Persons skilled in the art will appreciate that numerous variations and modifications will become apparent. All such variations and modifications which become apparent to persons skilled in the art, should be considered to fall within the spirit and scope that the invention broadly appearing before described.

1) A method for allowing a customer to perform a withdrawal query to determine whether a desired withdrawal amount and desired currency denominations can be withdrawn using an automated teller machine (ATM), the method being performed using one or more electronic processing devices, the method including:
a) receiving, from a client device of the customer, a withdrawal query request including the desired withdrawal amount and desired currency denominations;
b) performing one or more security checks based at least in part on the withdrawal query message;
c) in the event that the one or more security checks are passed, providing a status query message to an acquiring switch associated with a plurality of ATMs;
d) receiving, from the acquiring switch, a status query response indicative of a current status of one or more ATMs;
e) determining, by a polling process, at the acquiring switch, whether the desired withdrawal amount and desired currency denominations can be withdrawn from the one or more ATMs based on the status query response; and
f) providing, to the client device, an indication of whether the desired withdrawal amount and desired currency denominations can be withdrawn using at least one of the one or more ATMs.

2) A method according to claim 1, wherein the one or more security checks include checking that the desired withdrawal amount does not exceed a maximum withdrawal limit for the customer in a predetermined period.

3) A method according to claim 1, wherein the one or more security checks include checking that the withdrawal query request does not exceed a maximum query request limit for the customer in a predetermined period.

4) A method according to claim 2, wherein the predetermined period is one day.

5) A method according to claim 1, wherein, the method includes, in the event that at least one of the one or more security checks is not passed, providing, to the client device, a notification that the withdrawal query request has been denied.

6) A method according to claim 1, wherein the status query response is indicative of:
a) an operational status of each of the one or more ATMs; and
b) an available cash balance and/or breakdown of currency denomination of each of the one or more ATMs.

7) A method according to claim 6, wherein the method includes the acquiring switch receiving periodic operational status messages from each of the plurality of ATMs to allow the acquiring switch to maintain a record of the operational status of each of the ATM and provide an indication thereof as part of the status query response.

8) A method according to claim 6, wherein the method includes the acquiring switch receiving counter messages from each of the plurality of ATMs to allow the acquiring switch to maintain a record of the available cash balance and/or breakdown of currency denomination of each of the plurality of ATMs and provide an indication thereof as part of the status query response.

9) A method according to claim 8, wherein the method includes the acquiring switch maintaining the record of the available cash balance and/or breakdown of currency denomination of each of the plurality of ATMs by updating the available cash balance in response to counter messages indicative of any one of:
a) an amount of cash being loaded into the ATM; and
b) a cumulative amount of cash being dispensed from the ATM to customers at the ATM.

10) A method according to claim 6, wherein the method includes determining that the desired withdrawal amount cannot be withdrawn from an ATM in the event that at least one of:
a) the operational status of the ATM indicates that the ATM is at least one of:
i) in an inoperative state;
ii) in a cash out state;
iii) lacking the desired currency denominations; and
b) the desired withdrawal amount exceeds the available cash balance of the ATM.

11) A method according to claim 1, wherein:
a) in the event of a determination that the desired withdrawal amount and desired currency denominations can be withdrawn from at least one of the one or more ATMs, providing, to the client device, an indication confirming that the desired withdrawal amount can be withdrawn; and
b) in the event of a determination that the desired withdrawal amount or desired currency denominations cannot be withdrawn from any of the one or more ATMs, providing, to the client device, an indication of why the desired withdrawal amount cannot be withdrawn.

12) A method according to claim 1, wherein the withdrawal query request includes an indication of a customer selected ATM, the status query message and the status query response relating to the user selected ATM.

13) A method according to claim 1, wherein the withdrawal query request includes an indication of a location of the client device, the method including determining one or more nearby ATMs based on the location of the client device, the status query message and the status query response relating to the one or more nearby ATMs.

14) An apparatus for allowing a customer to perform a withdrawal query to determine whether a desired withdrawal amount in desired currency denominations can be withdrawn using an automated teller machine (ATM), the apparatus including one or more electronic processing devices configured to:
a) receive, from a client device of the customer, a withdrawal query request including a desired withdrawal amount and desired currency denominations;
b) perform one or more security checks based at least in part on the withdrawal query request;
c) in the event that the one or more security checks are passed, provide a status query message to an acquiring switch associated with a plurality of ATMs;
d) receive, from the acquiring switch, a status query response indicative of a current status of one or more ATMs;
e) determine, by a polling process, at the acquiring switch, whether the desired withdrawal amount and desired currency denominations can be withdrawn from the one or more ATMs based on the status query response; and
f) provide, to the client device, an indication of whether the desired withdrawal amount and desired currency denominations can be withdrawn using at least one of the one or more ATMs.

15) An apparatus according to claim 14, wherein one or more electronic processing devices are configured to communicate with the client device and the acquiring switch using one or more communications networks.

16) A method for allowing a customer to perform a withdrawal query to determine whether a desired withdrawal amount in desired currency denominations can be withdrawn using an automated teller machine (ATM), the method being performed using a client device, the method including:
a) obtaining, from the customer, a request to perform a withdrawal query;
b) obtaining, from the customer, an indication of the desired withdrawal amount and desired currency denominations;
c) generating a withdrawal query request including the desired withdrawal amount and desired currency denominations;
d) providing the withdrawal query request to an application server, to thereby cause the application server to determine whether the desired withdrawal amount and desired currency denominations can be withdrawn from one or more ATMs;
e) receiving, from the application server, an indication of whether the desired withdrawal amount and desired currency denominations can be withdrawn using at least one of the one or more ATMs; and
f) presenting the indication to the customer using a display of the client device.

17) A method according to claim 16, wherein the method includes the application server performing one or more security checks based at least in part on the withdrawal query request, and in the event that at least one of the one or more security checks is not passed, receiving, from the application server, a notification that the withdrawal query request has been denied.

18) A method according to claim 16, wherein:
a) in the event of the application server determining that the desired withdrawal amount and desired currency denominations can be withdrawn from at least one of the one or more ATMs, receiving, from the application server, an indication confirming that the desired withdrawal amount and desired currency denominations can be withdrawn; and
b) in the event of the application server determining that the desired withdrawal amount or desired currency denominations cannot be withdrawn from any of the one or more ATMs, receiving, from the application server, an indication of why the desired withdrawal amount cannot be withdrawn.

19) A method according to claim 1, wherein the method includes:
a) obtaining, from the customer, a selection of an ATM from a plurality of ATMs;
b) generating the withdrawal query request including an indication of the customer selected ATM; and
c) receiving an indication of whether the desired withdrawal amount and desired currency denominations can be withdrawn using the customer selected ATM.

20) A method according to claim 19, wherein the method includes:
a) presenting indications of the plurality of ATMs in corresponding locations on a map interface using the display; and
b) obtaining, from the customer, the selection of the ATM using the map interface.
